(19) United States
(12) Patent Application Publication
(10) Pub. No.: US 2020/0074753 A1
(43) Pub. Date: Mar. 5, 2020

(54) ELECTROMECHANICALLY COUPLED BARRIER, METHOD, AND SYSTEM TO PROVIDE TEMPORARY ACCESS TO A PARKING GARAGE AND A SECURE PHYSICAL SPACE OF THE PARKING GARAGE

(71) Applicants: Sadashiv Adiga, Hercules, CA (US); Chandra R. Patel, New York, NY (US)

(72) Inventors: Sadashiv Adiga, Hercules, CA (US); Chandra R. Patel, New York, NY (US)

(21) Appl. No.: 16/118,477

(22) Filed: Aug. 31, 2018

(51) Int. Cl. G07B 15/04; G08G 1/14; E04H 6/42; G08B 21/24

(52) U.S. Cl. CPC G07B 15/04; G08G 1/148; G06K 19/06009; G08B 21/24; E04H 6/422

(57) ABSTRACT

Disclosed are an electromechanically coupled barrier, a method, and/or a system to provide temporary access to a parking garage and a secure physical space of the parking garage. In one embodiment, an access control system of the parking garage includes a barrier, a controller, the secure physical space and an access control hardware. The barrier of parking garage physically moves in an open state and/or a closed state to permit an automobile to enter the parking garage and/or restrict the automobile from entering the parking garage. The controller electromechanically coupled with the barrier communicates a signal to move the barrier based on a command of a centralized data processing system. The secure physical space in the parking garage is designated for non-automobile parking uses. The access control hardware of the secure physical space restricts access to the secure physical space for a limited duration of time to an automobile operator.

### FIELD OF TECHNOLOGY

This disclosure relates generally to physical barriers in parking garages and, more particularly, to an electromechanically coupled barrier, a method, and/or a system to provide temporary access to a parking garage and a secure physical space of the parking garage.

### BACKGROUND

A parking garage may be a property in which operators of vehicles may park their vehicles (e.g., cars, bikes, trucks). Access into and out from the parking garage may be regulated through a barrier (e.g., a gate, a riser, a gate) A particular operator of a vehicle wishing to access the parking garage may need to agree to pay for a fee prior to gaining entry to and/or exiting from the parking garage. For example, until the fee is paid (e.g., or a ticket pulled from a controller next to the barrier and/or manual waiver obtained), the barrier may not transform into a position in which a vehicle utilized by the particular operator can enter and/or exit.

Policies and procedures to update a set of business rules and policies under which operators of vehicles are permitted to access the parking garage may be difficult to modify without extensive training of staff and local programming of the controller and/or the barrier. For example, the controller may not permit variable policies applied to different groups of operators. In addition, there may be no way to program the controller to permit drivers of ride sharing services to temporarily rest and/or access physical break rooms in the parking garage because hardware/software technology to control access to the garage gates may limit the potential utilization of the parking garages to physical parking of cars.

Therefore, underutilized parking space may limit the revenue potential of garage operators. Furthermore, higher rents of parking space may lead to traffic congestion on roadways. At the same time, automobile accidents may increase in cities with many ride sharing drivers routinely operate because of driver fatigue. Such drivers may roam streets for long periods of time without a place to rest. As a result, operators of parking garages may lose revenue opportunities while public safety is compromised.

### SUMMARY

Disclosed are an electromechanically coupled barrier, a method, and/or a system to provide temporary access to a parking garage and a secure physical space of the parking garage.

In one aspect, an access control system of a parking garage includes a barrier, a controller, a secure physical space and an access control hardware. The barrier of the access control system of the parking garage physically moves in a manner such that an open state of the barrier permits an automobile to transgress the barrier and enter the parking garage. Further, a closed state of the barrier of the access control system of the parking garage restricts the automobile from entering the parking garage.

The controller is electromechanically coupled with the barrier. In addition, the controller communicates a signal to the barrier to permit the barrier to move in the open state and/or the closed state based on a command of a centralized data processing system. The secure physical space in the parking garage is designated for non-automobile parking uses. The access control hardware of the secure physical space restricts access to the secure physical space for a limited duration of time to an operator of the automobile.

The command of the centralized data processing system may trigger in response to a request from a mobile device associated with the operator. The operator of the automobile may request an access to the secure physical space of the parking garage. The secure physical space may be a break room that permits the operator of the automobile to access a set of services to permit the operator to get access to a beverage, a snack, a seating area, and/or access to an internet service for the limited duration of time.

The limited duration of time may be set by a ride sharing service through which the operator of the vehicle is employed and/or a proprietor of the parking garage. The mobile device associated with the operator of the automobile may automatically trigger an alarm when the limited duration of time is about to expire to signal the automobile and the operator that they must exit the break area within the limited duration of time.

An announcement may be auditorily and/or visually triggered in the secure physical space announcing that the automobile of the operator must soon leave when the limited duration of time is about to expire. A time-based fine may be assessed to the operator of the vehicle and/or the ride sharing service by a proprietor of the parking garage based on an excess time when the limited duration of time is exceeded. The barrier may remain closed until the time-based fine is paid. Further, the time-based fine may be paid by the operator through the mobile device associated with the operator.

The secure physical space may be a storage locker room that permits the operator of the automobile to automatically open the storage locker with the mobile device when the operator approaches the storage locker during the limited duration of time. In addition, the secure physical space may be a bathroom, a restroom, a storage locker, an exhibition space, a café, a break room, a convenience store, a shopping mall, a restaurant, a retail store, an office space, an electric vehicle charging station and/or a bicycle repair station.

The command of the centralized data processing system may be communicated to the controller to move the barrier from the closed state to the open state. In addition, the command of the centralized data processing system may also allocate an available parking spot in the parking garage in which the automobile should park. The operator may receive a visual display of where the automobile is to park in the available parking spot through a navigation guidance delivered to the mobile device of the operator.

In another aspect, an access control system of a parking garage includes a barrier, a centralized data processing system and a controller. The barrier of the access control system of the parking garage physically moves in a manner such that an open state of the barrier permits an automobile to transgress the barrier and enter the parking garage. Further, a closed state of the barrier of the access control system of the parking garage restricts the automobile from entering the parking garage.

The centralized data processing system with a processor and a memory communicates real-time parking space availability in the parking garage to a mobile device associated with an operator. The centralized data processing system with the processor and the memory allocates an available parking spot in the parking garage to park the automobile of the requested automobile operator. In addition, the centralized data processing system with the processor and the memory communicates a command to move the barrier from the closed state to the open state.

The controller with an access control hardware of a secure physical space restricts access to the secure physical space for a limited duration of time to the operator of the automobile. The secure physical space in the parking garage is designated for non-automobile parking uses. Further, the controller communicates a signal to the barrier to permit the barrier to move in the open state and/or the closed state based on the command of the centralized data processing system.

The barrier may have a display unit to show an allocated parking spot for the automobile and a direction to the allotted parking spot to park the automobile.

In yet another aspect, a method of a centralized data processing server includes requesting access to a parking garage and a secure physical space of the parking garage through a mobile device associated with an operator. The method of the centralized data processing server includes communicating real-time parking space availability in the parking garage along with a payment request to the mobile device associated with the operator through a controller. The method of the centralized data processing server includes allotting a parking spot for the requested automobile operator upon completion of the payment procedure.

In addition, the method of the centralized data processing server includes communicating the allotted parking spot information with an authentication code to open a garage barrier. The method of the centralized data processing server includes transmitting a signal through the controller to the barrier to permit the barrier to move in the open state on entering the valid authentication code to enable the automobile to drive into the parking garage and park the automobile at the allotted parking spot.

The method of the centralized data processing server further includes authorizing the operator of the automobile to access the secure physical space for a limited duration of time. The method of the centralized data processing server includes triggering an alarm of the mobile device associated with the operator when the limited duration of time to access the secure physical space is about to expire. The method of the centralized data processing server includes transmitting a signal through the controller to the barrier to permit the barrier to move in the open state to enable the automobile to exit from the garage.

The authentication code to open the garage barrier may be a QR code, a barcode, an alphanumeric character, and/or a pattern.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is an overview of an access control system of a parking garage to enable an automobile operator to park an automobile into the parking garage through an electromechanically coupled barrier, according to one embodiment.

FIG. 2A is a network view of a centralized data processing server of FIG. 1 receiving a request to access the parking garage and communicating a signal to a controller to operate the barrier in an open state, according to one embodiment.

FIG. 2B is another network view of the centralized data processing server of the access control system of FIG. 1 triggering an alarm of the mobile device associated with the operator on receiving an access time expiry signal from an access control hardware, according to one embodiment.

FIG. 3 is a partial top view of architecture of the parking garage of FIG. 1 to enable the automobile operator to access a secure physical space of the parking garage, according to one embodiment.

FIG. 4A is a user interface view displaying an access request sent by the mobile device associated with the automobile operator to the centralized data processing server of FIG. 1, according to one embodiment.

FIG. 4B is another user interface view displaying the notification messages communicated by of the centralized data processing server of FIG. 1 to enable the automobile operator to access the secure physical space of the parking garage, according to one embodiment.

FIG. 5 is a critical path view illustrating a flow based on time where an automobile operator requests an access to the parking garage and the secure physical space in the parking garage for a limited duration of time using the centralized data processing server of FIG. 1, according to one embodiment.

FIG. 6 is a process flow detailing the operations involved in accessing the parking garage and the secure physical space in the parking garage for a limited duration of time using the centralized data processing server of FIG. 1, according to one embodiment.

Other features of the present embodiments will be apparent from the accompanying drawings and from the detailed description that follows.

### DETAILED DESCRIPTION

Disclosed are an electromechanically coupled barrier 114, a method, and/or a system to provide temporary access to a parking garage 110 and a secure physical space 112 of the parking garage 110. In one embodiment, an access control system of a parking garage 110 includes a barrier 114, a controller 108, a secure physical space 112 and an access control hardware 208. The barrier 114 of the access control system of the parking garage 110 physically moves in a manner such that an open state of the barrier 114 permits an automobile 120 to transgress the barrier 114 and enter the parking garage 110. Further, a closed state of the barrier 114 of the access control system of the parking garage 110 restricts the automobile 120 from entering the parking garage 110.

The controller 108 is electromechanically coupled with the barrier 114. In addition, the controller 108 communicates a signal (e.g., transition signal 206) to the barrier 114 to permit the barrier 114 to move in the open state and/or the closed state based on a command (e.g., transition signal 206) of a centralized data processing system (e.g., centralized data processing server 100). The secure physical space 112 in the parking garage 110 is designated for non-automobile parking uses. The access control hardware 208 of the secure physical space 112 restricts access to the secure physical space 112 for a limited duration of time (e.g., allotted access time 402) to an operator (e.g., automobile operator 116) of the automobile 120.

The command (e.g., space availability and payment request 202) of the centralized data processing system (e.g., centralized data processing server 100) may trigger in response to a request (e.g., access request 200) from a mobile device 118 associated with the automobile operator 116. The operator (e.g., automobile operator 116) of the automobile 120 may request (e.g., access request 200) an access to the secure physical space 112 of the parking garage 110. The secure physical space 112 may be a break room that permits the operator (e.g., automobile operator 116) of the automobile 120 to access a set of services to permit the operator (e.g., automobile operator 116) to get access to a beverage, a snack, a seating area, and/or access to an internet service for the limited duration of time (e.g., allotted access time 402).

The limited duration of time (e.g., allotted access time 402) may be set by a ride sharing service through which the operator (e.g., automobile operator 116) of the vehicle (e.g., operator 120) is employed and/or a proprietor of the parking garage 110. The mobile device 118 associated with the operator (e.g., automobile operator 116) of the automobile 120 may automatically trigger an alarm (e.g., trigger alarm 212) when the limited duration of time (e.g., allotted access time 402) is about to expire signaling the automobile 120 and the operator (e.g., automobile operator 116) that they must exit the break area (e.g., secure physical space 112) within the limited duration of time (e.g., allotted access time 402).

An announcement may be auditorily and/or visually triggered in the secure physical space 112 announcing that the automobile 120 of the operator (e.g., automobile operator 116) must soon leave when the limited duration of time (e.g., allotted access time 402) is about to expire. A time-based fine may be assessed to the operator (e.g., automobile operator 116) of the vehicle (e.g., automobile 120) and/or the ride sharing service by a proprietor of the parking garage 110 based on an excess time when the limited duration of time (e.g., allotted access time 402) is exceeded. The barrier 114 may remain closed until the time-based fine is paid. Further, the time-based fine may be paid by the operator (e.g., automobile operator 116) through the mobile device 118 associated with the operator (e.g., automobile operator 116).

The secure physical space 112 may be a storage locker room that permits the operator (e.g., automobile operator 116) of the automobile 120 to automatically open the storage locker with the mobile device 118 when the automobile operator 116 approaches the storage locker during the limited duration of time (e.g., allotted access time 402). In addition, the secure physical space 112 may be a bathroom, a restroom, a storage locker, an exhibition space, a café, a break room, a convenience store, a shopping mall, a restaurant, a retail store, an office space, an electric vehicle charging station and/or a bicycle repair station.

The command (e.g., transition signal 206) of the centralized data processing system 100 may be communicated to the controller 108 to move the barrier 114 from the closed state to the open state. In addition, the command (e.g., space availability and payment request 202) of the centralized data processing system 100 may also allocate an available parking spot (e.g., allotted parking spot 400) in the parking garage 110 in which the automobile 120 should park. The automobile operator 116 may receive a visual display (e.g., navigation 408) of where the automobile 120 is to park in the available parking spot (e.g., allotted parking spot 400) through a navigation 408 guidance delivered to the mobile device 118 of the operator (e.g., automobile operator 116).

In another embodiment, an access control system of a parking garage 110 includes a barrier 114, a centralized data processing system 100 and a controller 108. The barrier 114 of the access control system of the parking garage 110 physically moves in a manner such that an open state of the barrier 114 permits an automobile 120 to transgress the barrier 114 and enter the parking garage 110. Further, a closed state of the barrier 114 of the access control system of the parking garage 110 restricts the automobile 120 from entering the parking garage 110.

The centralized data processing system 100 with a processor 104 and a memory 102 communicates real-time parking space availability (e.g., space availability and payment request 202) in the parking garage 110 to a mobile device 118 associated with an operator (e.g., automobile operator 116). The centralized data processing system 100 with the processor 104 and the memory 102 allocates an available parking spot (e.g., allotted parking spot 400) in the parking garage 110 to park the automobile 120 of the requested automobile operator 116. In addition, the centralized data processing system 100 with the processor 104 and the memory 102 communicates a command (e.g., transition signal 206) to move the barrier 114 from the closed state to the open state.

The controller 108 with an access control hardware 208 of a secure physical space 112 restricts access to the secure physical space 112 for a limited duration of time (e.g., allotted access time 402) to the automobile operator 116. The secure physical space 112 in the parking garage 110 is designated for non-automobile parking uses. Further, the controller 108 communicates a signal (e.g., transition signal 206) to the barrier 114 to permit the barrier 114 to move in the open state and/or the closed state based on the command (e.g., transition signal 206) of the centralized data processing system 100.

The barrier 114 may have a display unit to show an allocated parking spot 400 for the automobile 120 and a direction (e.g., through navigation 408) to the allotted parking spot 400 to park the automobile 120.

In yet another embodiment, a method of a centralized data processing server 100 includes requesting access (e.g., access request 200) to a parking garage 110 and a secure physical space 112 of the parking garage 110 through a mobile device 118 associated with an automobile operator 116. The method of the centralized data processing server 100 includes communicating real-time parking space availability (e.g., space availability and payment request 202) in the parking garage 110 along with a payment request to the mobile device 118 associated with the automobile operator 116 through a controller 108. The method of the centralized data processing server 100 includes allotting a parking spot for the requested automobile operator 116 upon completion of the payment 204 procedure.

In addition, the method of the centralized data processing server 100 includes communicating the allotted parking spot 400 information with an authentication code 404 to open a garage (e.g., parking garage 110) barrier 114. The method of the centralized data processing server 100 includes transmitting a signal (e.g., transition signal 206) through the controller 108 to the barrier 114 to permit the barrier 114 to move in the open state on entering the valid authentication code 404 to enable the automobile 120 to drive into the parking garage 110 and park the automobile 120 at the allotted parking spot 400.

The method of the centralized data processing server 100 further includes authorizing the operator 116 of the automobile 120 to access the secure physical space 112 for a limited duration of time (e.g., allotted access time 402). The method of the centralized data processing server 100 includes triggering an alarm (e.g., trigger alarm 212) of the mobile device 118 associated with the operator 116 when the limited duration of time (e.g., allotted access time 402) to access the secure physical space 112 is about to expire. The method of the centralized data processing server 100 includes transmitting a signal (e.g., transition signal 206) through the controller 108 to the barrier 114 to permit the barrier 114 to move in the open state to enable the automobile 120 to exit from the garage 110.

The authentication code 404 to open the garage (e.g., parking garage 110) barrier 114 may be a QR code, a barcode, an alphanumeric character, and/or a pattern.

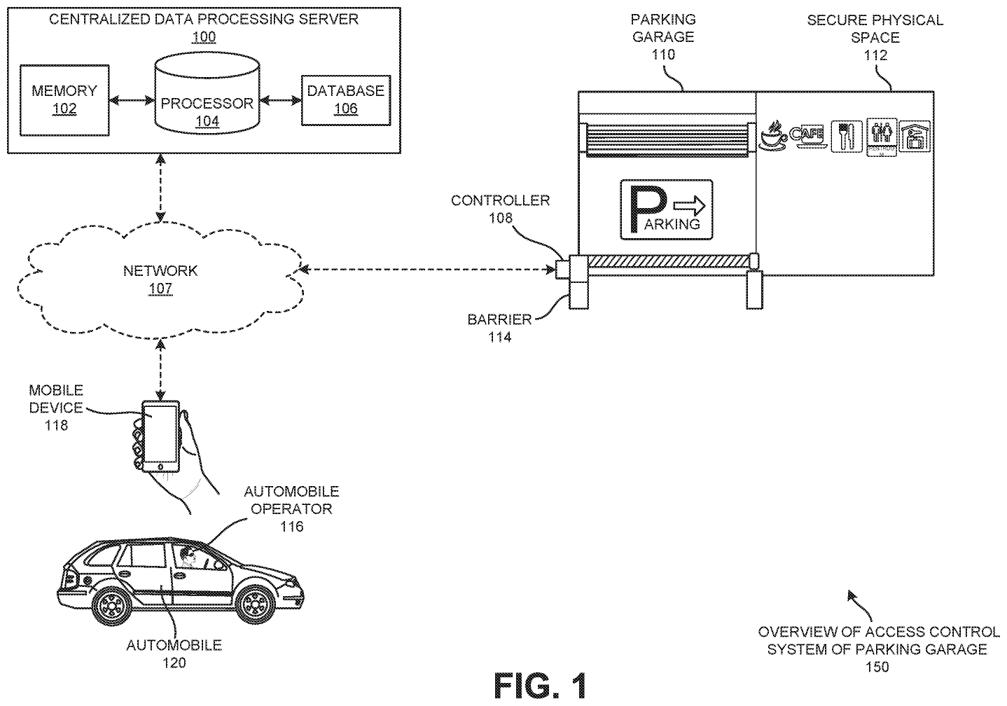

FIG. 1 is an overview 150 of an access control system of a parking garage 110 to enable an automobile operator 116 to park an automobile 120 into the parking garage 110 through an electromechanically coupled barrier 114, according to one embodiment. Particularly, FIG. 1 illustrates a centralized data processing server 100, a memory 102, a processor 104, a database 106, a network 107, a controller 108, a parking garage 110, a secure physical space 112, a barrier 114, an automobile operator 116, a mobile device 118, and an automobile 120, according to one embodiment.

The centralized data processing server 100 may be a computing system to monitor the operations of the access control system of the parking garage 110 to enable the automobile operator 116 to temporary access the secure physical space 112 of the parking garage 110. The centralized data processing server 100 with the processor 104 and the memory 102 may be communicatively connected to the mobile device 118 and the controller 108 through the network 107. The centralized data processing server 100 may receive access request 200 from the mobile device 118 associated with the automobile operator 116, according to one embodiment.

The centralized data processing server 100 may allot the parking spot (e.g., allotted parking spot 400) for vehicle (e.g., automobile 120) of the requested automobile operator 116. The centralized data processing server 100 may track the real time location of the automobile 120 through the network 107. The centralized data processing server 100 may communicate a signal (e.g., transition signal 206) to the controller 108 to operate the barrier 114 in the open state and/or the closed state. The centralized data processing server 100 may authorize the automobile operator 116 to access the secure physical space 112 for the limited duration of time (e.g., allotted access time 402), according to one embodiment.

The centralized data processing server 100 may transmit a navigation 408 guidance to the mobile device 118 of the automobile operator 116 to park the automobile 120 in the allotted parking spot 400. The centralized data processing server 100 may trigger auditory and/or visually announcement in the secure physical space 112 to notify the automobile operator 116 to leave soon when the limited duration of time (e.g., allotted access time 402) is about to expire. Further, the centralized data processing server 100 may send various notifications regarding the coupons and the reservations for the automobile operator 116, according to one embodiment.

The memory 102 may be a computer hardware device used to store information for immediate use of the centralized data processing server 100. The processor 104 may be a logic circuitry that responds to and processes the basic instructions to drive the centralized data processing server 100. The database 106 may be an easily accessible to a large amount of information stored in the centralized data processing server 100, according to one embodiment.

The controller 108 may be electromechanically coupled with the barrier 114 to manage the operation of the barrier 114 based on the command (e.g., transition signal 206) received from the centralized data processing server 100. The controller 108 may be communicatively coupled with the centralized data processing server 100 through the network 107. The controller 108 may have an access control hardware 208 to restrict access of the secure physical space 112 for the limited duration of time (e.g., allotted access time 402). The controller 108 may scan the authentication code 404 to verify the valid user (e.g., automobile operator 116). The controller 108 may communicate a signal (e.g., transition signal 206) to the barrier 114 to permit the barrier 114 to move in the open state and/or the closed state, according to one embodiment.

The parking garage 110 may be a property and/or building to enable the automobile operator 116 to park the automobile 120 and access the secure physical space 112 for the limited duration of time (e.g., allotted access time 402). The parking garage 110 may allow the automobile operator 116 to park their automobile 120 at the allotted parking spot 400. The parking garage 110 may have large number of parking spaces for automobile 120 parking that to be monitored by the centralized data processing server 100, according to one embodiment.

The secure physical space 112 may be a chamber in the parking garage 110 designated for non-automobile parking uses. The secure physical space 112 may be restricted to access for the limited duration of time (e.g., allotted access time 402). The secure physical space 112 may be non-accessible for the non-authorized automobile operators 120. The secure physical space 112 of the parking garage 110 may be bounded inside the parking garage 110. The secure physical space 112 may be accessed from inside of the parking garage 110. The secure physical space 112 may permit the operator 116 of the automobile 120 to access a set of services to permit the operator 116 to get access to a beverage, a snack, a seating area, and/or access to an internet service for the limited duration of time (e.g., allotted access time 402), according to one embodiment.

The secure physical space 112 may permit the automobile operator 116 to automatically open the storage locker with the mobile device 118 when the operator 116 approaches the storage locker during the limited duration of time (e.g., allotted access time 402). The secure physical space 112 in the parking garage 110 may be a bathroom, a restroom, a storage locker, an exhibition space, a café, a break room, a convenience store, a shopping mall, a restaurant, a retail store, an office space, an electric vehicle charging station and/or a bicycle repair station, according to one embodiment.

The barrier 114 may be a barricade of the parking garage 110 at the entrance of the parking garage 110 to restrict the non-authorized automobile 120 from entering the parking garage 110. The barrier 114 may be operated in an open state to permit the automobile 120 to enter the parking garage 110. The barrier 114 may be operated in a closed state to restrict the automobile 120 from entering the parking garage 110, according to one embodiment.

The barrier 114 may be electromechanically coupled with the controller 108 to operate based on the command (e.g., transition signal 206) received from the centralized data processing server 100. The barrier 114 may move in open state on entering the valid authentication code 404. The barrier 114 may have a display unit to show an allocated parking spot 400 for the automobile 120 and a direction (e.g., navigation 408) to the allotted parking spot 400 to park the automobile 120. The barrier 114 may remain closed until the time-based fine is paid when the temporary access time (e.g., allotted access time 402) is exceeded, according to one embodiment.

The automobile operator 116 may be a vehicle (e.g., automobile 120) driver who wishes to park his vehicle (e.g., automobile 120) in the parking garage 110 and temporary access the secure physical space 112. The automobile operator 116 may request an access (e.g., access request 200) to the parking garage 110 and the secure physical space 112 of the parking garage 110 through the mobile device 118. The automobile operator 116 may use the received authentication code 404 to enable the transition of the barrier 114 in the open state, according to one embodiment.

The automobile operator 116 may follow the navigation 408 guidance delivered to the mobile device 118 to park the automobile 120 at the allotted parking spot 400. The automobile operator 116 may access the secure physical space 112 for limited duration of time (e.g., allotted access time 402). The automobile operator 116 may leave when the limited duration of time (e.g., allotted access time 402) to access the secure physical space 112 is about to expire. The automobile operator 116 may need to pay time-based fine when the access time (e.g., allotted access time 402) of the secure physical space 112 is exceeded, according to one embodiment.

The mobile device 118 may be a portable device of the automobile operator 116 to communicate with the centralized data processing server 100 to secure the parking spot (e.g., allotted parking spot 400) in the parking garage 110. The mobile device 118 associated with the automobile operator 116 may be a smartphone, a tablet, a location service enabled portable device, a personal planner and/or any computing device. The mobile device 118 may enable the automobile operator 116 to make payments 204. The mobile device 118 may receive various notifications regarding the coupons and the reservations from the centralized data processing server 100 through the network 107, according to one embodiment.

The automobile 120 may be a vehicle of the user (e.g., automobile operator 116) that needs to be park in the parking garage 110 to access the secure physical space 112. The automobile 120 may be a car, a bike, and/or a heavy motor vehicle such as a bus and/or a truck. The automobile 120 may be driven into the parking garage 110 when the garage barrier 114 is in open state. The automobile 120 may be parked at the allotted parking spot 400 assigned by the centralized data processing server 100, according to one embodiment.

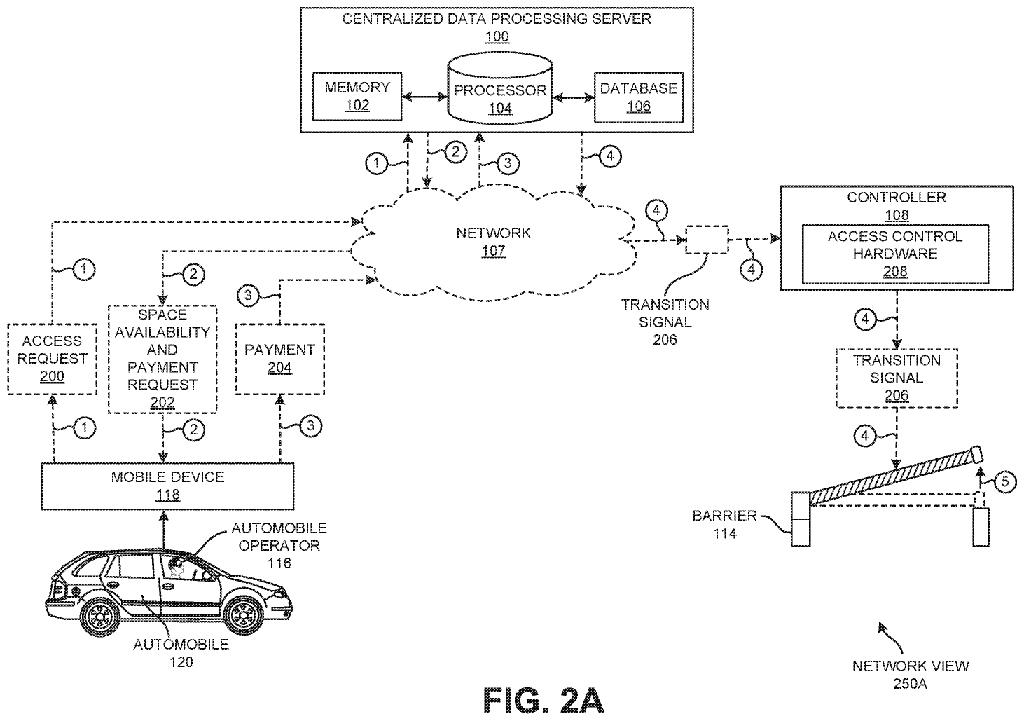

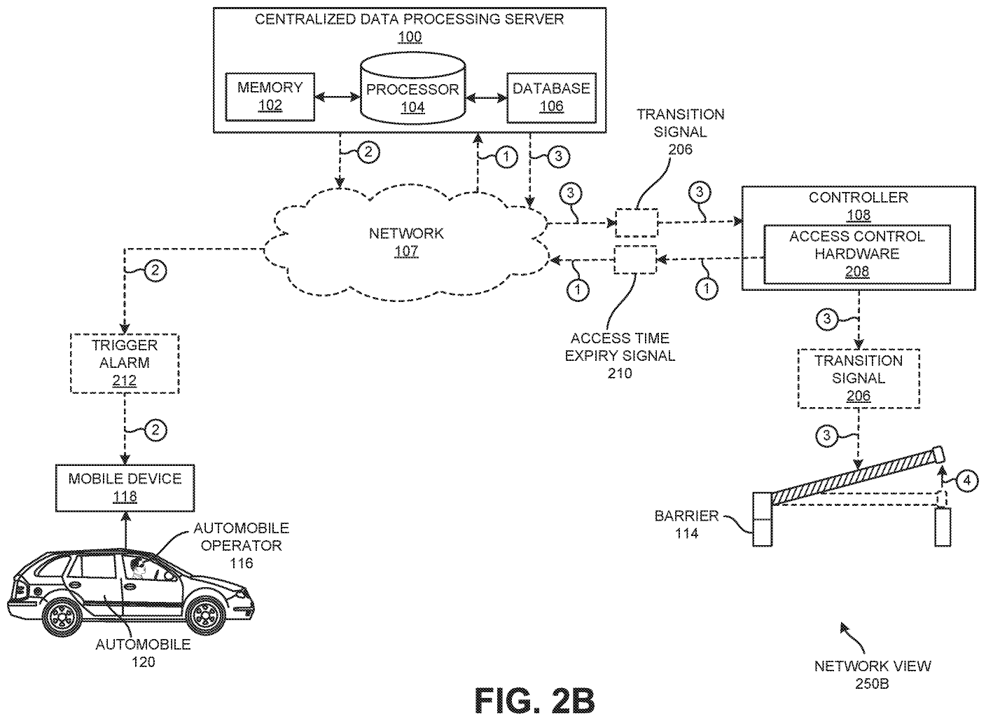

FIG. 2A is a network view 250A of a centralized data processing server 100 of FIG. 1 receiving a request (e.g., access request 200) to access the parking garage 110 and communicating a signal (e.g., transition signal 206) to a controller 108 to operate the barrier 114 in an open state, according to one embodiment. Particularly, FIG. 2A illustrates an access request 200, a space availability and payment request 202, a payment 204, a transition signal 206, and an access control hardware 208, according to one embodiment.

The access request 200 may be an inquiry signal asking permission to access the parking garage 110 and the secure parking space 112 for the limited duration of time (e.g., allotted access time 402). The access request 200 may be transmitted through the mobile device 118 of the automobile operator 116 to the centralized data processing server 100. In another embodiment, the access request 200 may enable the automobile operator 116 to choose desired parking spot (e.g., allotted parking spot 400) and accessing time (e.g., allotted access time 402) of the secure physical space 112, according to one embodiment.

The space availability and payment request 202 may be a triggered response communicated from the centralized data processing server 100 to provide information regarding the unoccupied parking space in the parking garage 110 to park the automobile 120. The space availability and the payment request 202 may vary based on a type of automobile 120 and/or duration (e.g., allotted access time 402) to access the secure physical space 112, according to one embodiment.

The payment 204 may be a fees paid by the automobile operator 116 using the mobile device 118 through the network 107. The payment 204 may be done to secure the parking spot (e.g., allotted parking spot 400) in the parking garage 110 and access the secure physical space 112. The payment 204 may be paid to the centralized data processing server 100 through the network 107, according to one embodiment.

The transition signal 206 may be command to operate the electromechanically coupled barrier 114 in open state and/or closed state. The transition signal 206 may be communicated by the centralized data processing server 100 to the barrier 114 through the controller 108 after successful completion of the payment 204 procedure. Further, the transition signal 206 may be communicated to the barrier 114 when the limited duration of time (e.g., allotted access time 402) to access the secure physical space 112 is expired, according to one embodiment.

The access control hardware 208 may be a time tracking module configured to monitor the access time (e.g., allotted access time 402) of the automobile operator 116 in the secure physical space 112. The access control hardware 208 may be integrated with the controller 108. The access control hardware 208 may be able to simultaneously track the access time (e.g., allotted access time 402) of multiple automobile operators 116. The access control hardware 208 may communicate the access time expiry signal 210 to the centralized processing server 100 through the network 107. The access control hardware 208 may communicate the access time expiry signal 210 when the limited duration of time (e.g., (e.g., allotted access time 402) to access the secure physical space 112 is about to expire, according to one embodiment.

FIG. 2A illustrates the number of operations between the mobile device 118, the centralized data processing server 100, the controller 108 and the barrier 114 of the parking garage 110. Particularly, circle ‘1’ of FIG. 2A illustrates the access request 200 being communicated by the mobile device 118 of the associated automobile operator 116 to the centralized data processing server 100 through the network 107. The circle ‘2’ shows the space availability and payment request 202 being communicated by the centralized data processing server 100 to the mobile device 118 to secure the parking spot (e.g., allotted parking spot 400) in the parking garage 110, according to one embodiment.

The circle ‘3’ shows the payment 204 procedure being completed by the automobile operator 116 through the mobile device 118 and transmitted to the centralized data processing server 100. The circle ‘4’ shows the transition signal 206 being communicated from the centralized data processing server 100 to the controller 108 through the network 107. The circle ‘4’ further shows the transition signal 206 being communicated from the controller 108 to the electromechanically coupled barrier 114 to permit the barrier 114 to move in the open state. The circle ‘5’ shows the transition of the barrier 114 from closed state to open state to enable the automobile 120 to enter into the parking garage 110, according to one embodiment.

FIG. 2B is another network view 250B of the centralized data processing server 100 of the access control system of FIG. 1 triggering an alarm (e.g., trigger alarm 212) of the mobile device 118 associated with the automobile operator 116 on receiving an access time expiry signal 210 from an access control hardware 208, according to one embodiment. Particularly, FIG. 2B illustrates an access time expiry signal 210, and a trigger alarm 212, according to one embodiment.

The access time expiry signal 210 may be a command transmitted to notify that the limited duration of time (e.g., allotted access time 402) of the associated automobile operator 116 to access the secure physical space 112 is about to expire. The access time expiry signal 210 may be communicated from the access control hardware 208 to the centralized data processing server 100 through the network 107. The access time expiry signal 210 may be tracked using the access control hardware 208 of the controller 108, according to one embodiment.

The trigger alarm 212 may be an alert signal transmitted to the mobile device 118 of the associated automobile operator 116 to notify that the limited duration of time (e.g., allotted access time 402) to access the secure physical space 112 is about to expire. The trigger alarm 212 may be transmitted by the centralized data processing server 100 to the mobile device 118 of the associated automobile operator 116 through the network 107, according to one embodiment.

FIG. 2B illustrates the number of operations between the access control hardware 208, the centralized data processing server 100, the mobile device 118, the controller 108 and the barrier 114 of the parking garage 110. Particularly, circle ‘1’ of FIG. 2B illustrates the access time expiry signal 210 being transmitted from the access control hardware 208 of the controller 108 to the centralized data processing server 100 through the network 107 when the limited duration of time (e.g., allotted access time 402) to access the secure physical space 112 is about to expire, according to one embodiment.

The circle ‘2’ shows the trigger alarm 212 being transmitted from the centralized data processing server 100 to the mobile device 118 to notify the automobile operator 116 that the limited duration of time (e.g., allotted access time 402) to access the secure physical space 112 is about to expire. The circle ‘3’ shows the transition signal 206 being communicated from the centralized data processing server 100 to the controller 208. The circle ‘3’ further shows the transition signal 206 being communicated from the controller 108 to the electromechanically coupled barrier 114 to permit the barrier 114 to move in the open state. The circle ‘4’ shows the transition of the barrier 114 from closed state to open state to enable the automobile 120 to drive out from the parking garage 110, according to one embodiment.

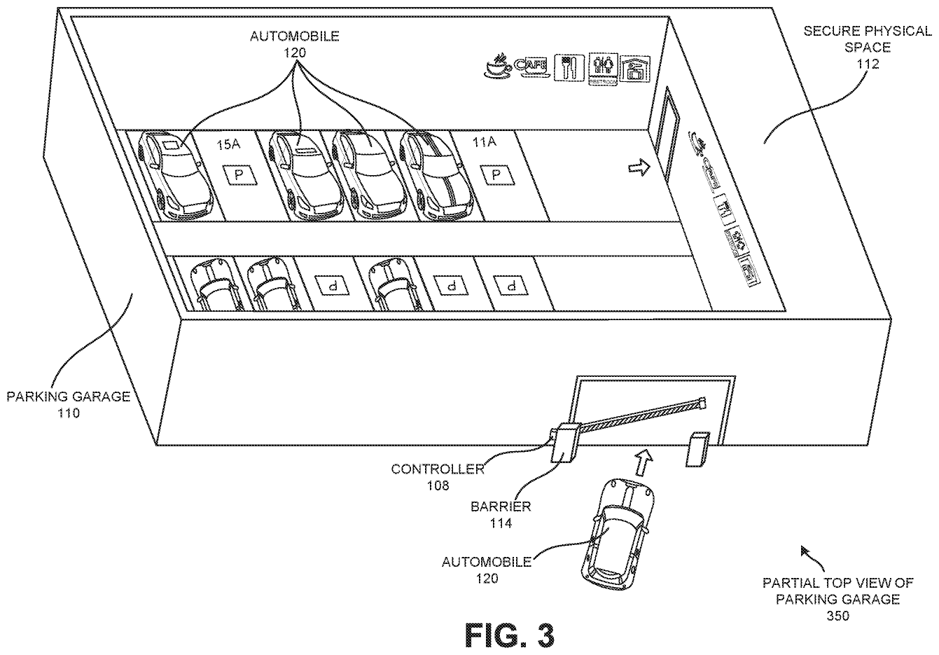

FIG. 3 is a partial top view 350 of architecture of the parking garage 110 of FIG. 1 to enable the automobile operator 116 to access a secure physical space 112 of the parking garage 110, according to one embodiment. FIG. 3 shows the automobile 120 entering into the parking garage 110 through the barrier 114 when the barrier 114 moves from the closed state to the open state. The automobile operator 116 may park the automobile 120 at the parking spot (e.g., allotted parking spot 400) allocated by the centralized data processing server 100. The automobile operator 116 may access the secure physical space 112 for limited duration of time (e.g., allotted access time 402), according to one embodiment.

The architecture of the parking garage 110 may restrict the automobile operator 116 to access the secure physical space 112 from inside the parking garage 110. The automobile operator 116 may need to leave when the limited duration of time (e.g., allotted access time 402) to access the secure physical space 112 is about to expire. The automobile operator 116 may drive out the automobile 120 through the barrier 114 when the barrier 114 moves from the closed state to the open state, according to one embodiment.

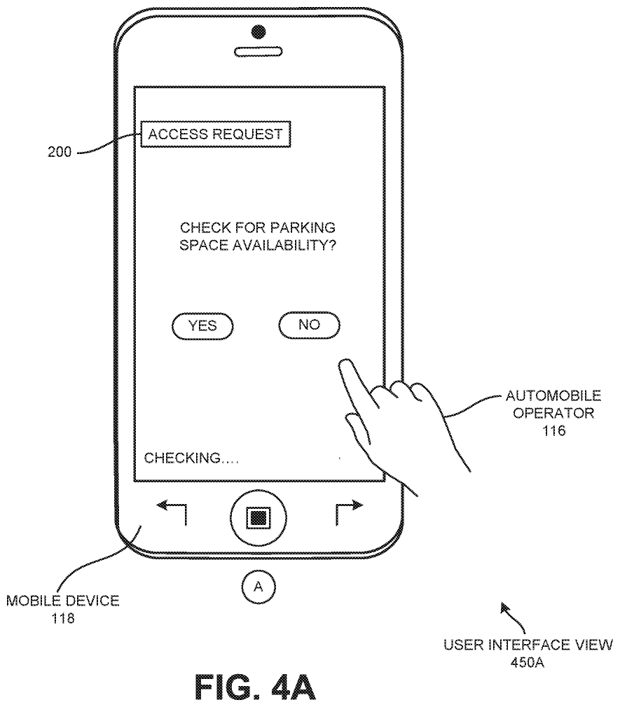

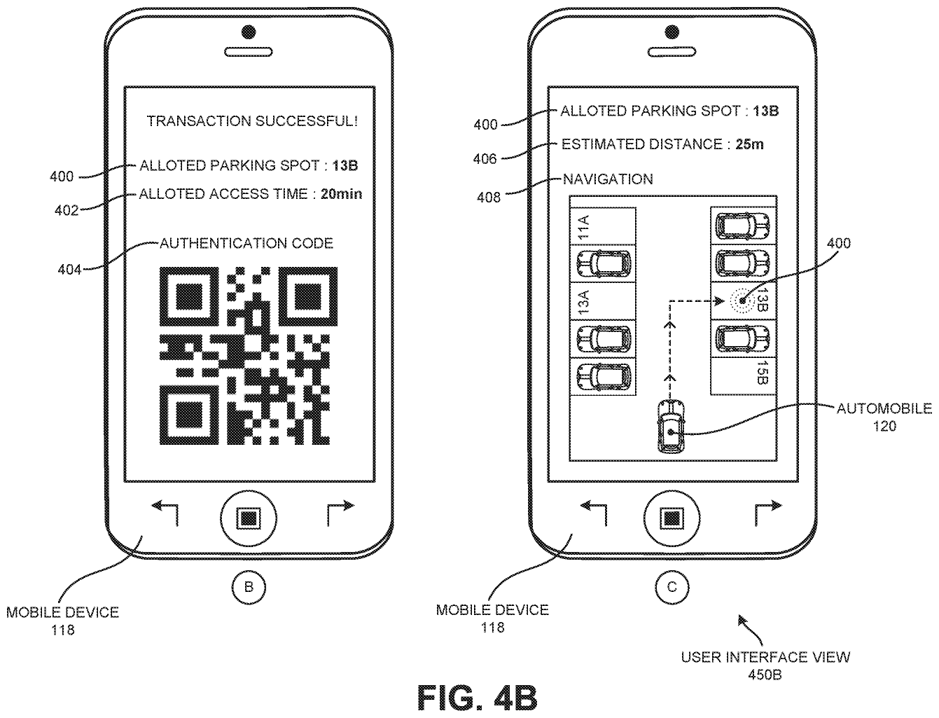

FIG. 4A is a user interface view 450A displaying an access request 200 sent by the mobile device 118 associated with the automobile operator 116 to the centralized data processing server 100 of FIG. 1, according to one embodiment. In user interface A, the automobile operator 116 may be able to request (e.g., access request 200) to access the parking garage 110 and the secure physical space 112 of the parking garage 110. The automobile operator 116 may be able to check real time parking space availability (e.g., through received space availability and payment request 202) in the parking garage 110, according to one embodiment.

The centralized data processing server 100 may determine real time parking space availability in the parking garage 110. The centralized data processing server 100 may further extract the allocated access time 402 for the particular automobile operator 116 by the ride sharing service through which of the automobile 120 is employed. In another embodiment, the automobile operator 116 may choose the desired parking spot (e.g., allotted parking spot 400) in the parking garage 110 and the temporary access time (e.g., allotted access time 402) to access the secure physical space 112, according to one embodiment.

FIG. 4B is another user interface view 450B displaying the notification messages communicated by of the centralized data processing server 100 of FIG. 1 to enable the automobile operator 116 to access the secure physical space 112 of the parking garage 110, according to one embodiment. Particularly, FIG. 2B illustrates an allotted parking spot 400, an allotted access time 402, an authentication code 404, an estimated distance 406, and a navigation 408, according to one embodiment.

The allotted parking spot 400 may be a particular space in the parking garage 110 reserved to park the automobile 120. The allotted parking spot 400 may be assigned by the centralized data processing server 100. The allotted parking spot 400 may be communicated to the mobile device 118 of the associate automobile operator 116. The allotted parking spot 400 may be set as the destination point in the navigation 408 guide provided by the centralized data processing server 100 to park the automobile 120 at the assigned space, according to one embodiment.

The allotted access time 402 may be a specific time assigned to the particular automobile operator 116 to temporary use the secure physical space 112. The allotted access time 402 may be tracked by the access control hardware 208 of the controller. The allotted access time 402 may be set by a ride sharing service through which the operator 116 of the vehicle (e.g., automobile 120) is employed and/or a proprietor of the parking garage 110. In another embodiment, the allotted access time 402 may be set by the automobile operator 116, according to one embodiment.

The authentication code 404 may be a unique identifier used to verify the valid automobile operator 116. The authentication code 404 may be communicated by the centralized data processing server 100 to the mobile device 118 of the associated automobile operator 116. The authentication code 404 may be scanned by the controller 108 electromechanically coupled with the barrier 114. The authentication code 404 may also be used to automatically open the storage locker in the secure physical space 112. The authentication code 404 to open the garage barrier 114 may be a QR code, a barcode, an alphanumeric character, and/or a pattern, according to one embodiment.

The estimated distance 406 may be an approximate distance of the allotted parking spot 400 in the parking garage 110 from the current location of the automobile 120. The estimated distance 406 may be tracked in real-time by the centralized data processing server 100. The navigation 408 may direct the automobile 120 to find a way from current location of the automobile 120 to the allotted parking spot 400 in the parking garage 110. The navigation 408 may be provided to the mobile device 118 of the associated automobile operator 116 in real time considering the traffic updates, according to one embodiment.

In user interface B, the automobile operator 116 may be able to view the allotted parking spot 400 in the parking garage 110 and the allotted access time 402 to access the secure physical space 112. The mobile device 118 may display the unique authentication code 404 to enable the automobile 120 to enter into the parking garage 110. In another embodiment, the mobile device 118 may display the parking fare (e.g., payment 204) and enable the automobile operator 116 to pay the parking fare (e.g., payment 204) through the user interface B, according to one embodiment.

In user interface C of the mobile device 118 may enable the automobile operator 116 to view the estimated distance 406 from the current location of the automobile 120. The user interface C may further display the navigation 408 guide to reach at the allotted parking spot 400 in the parking garage 110 from the current location of the automobile 120, according to one embodiment.

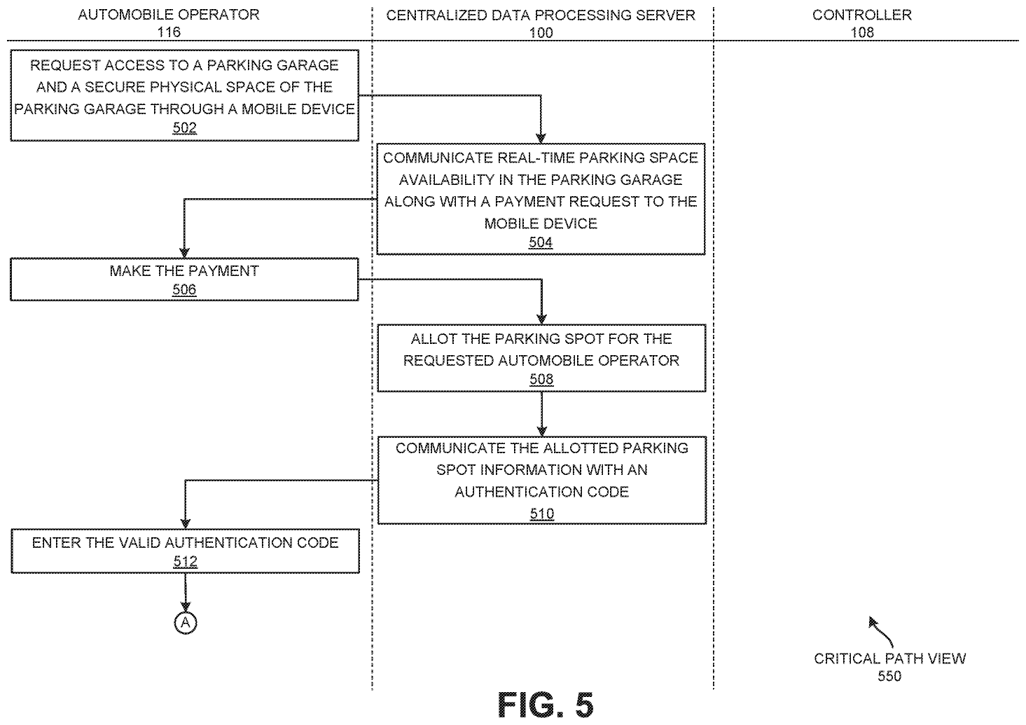

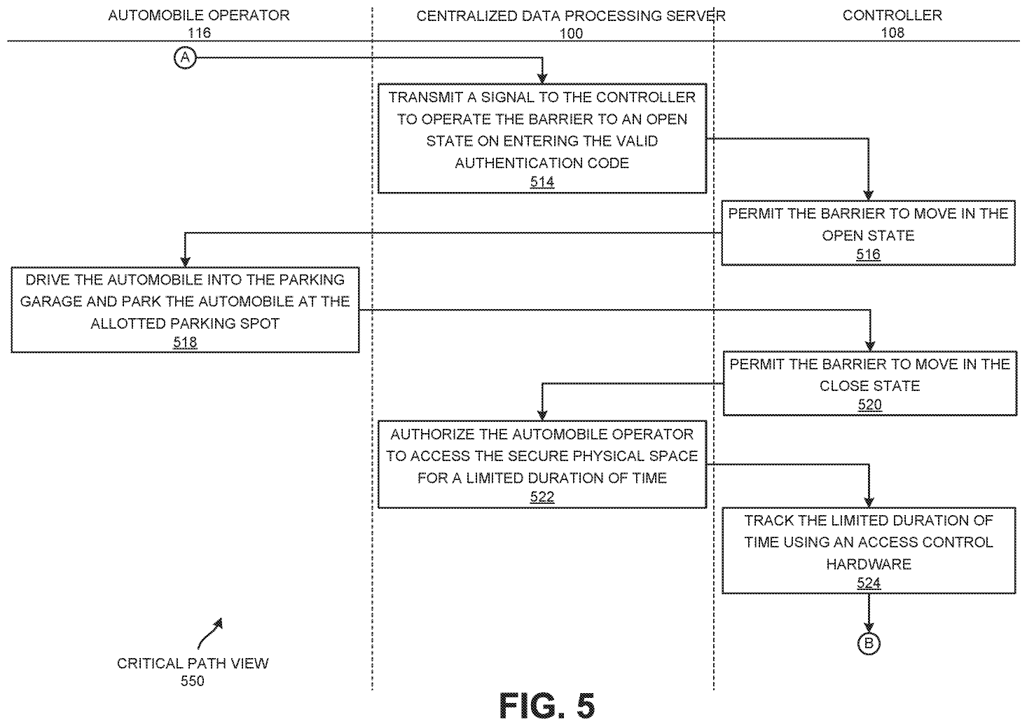

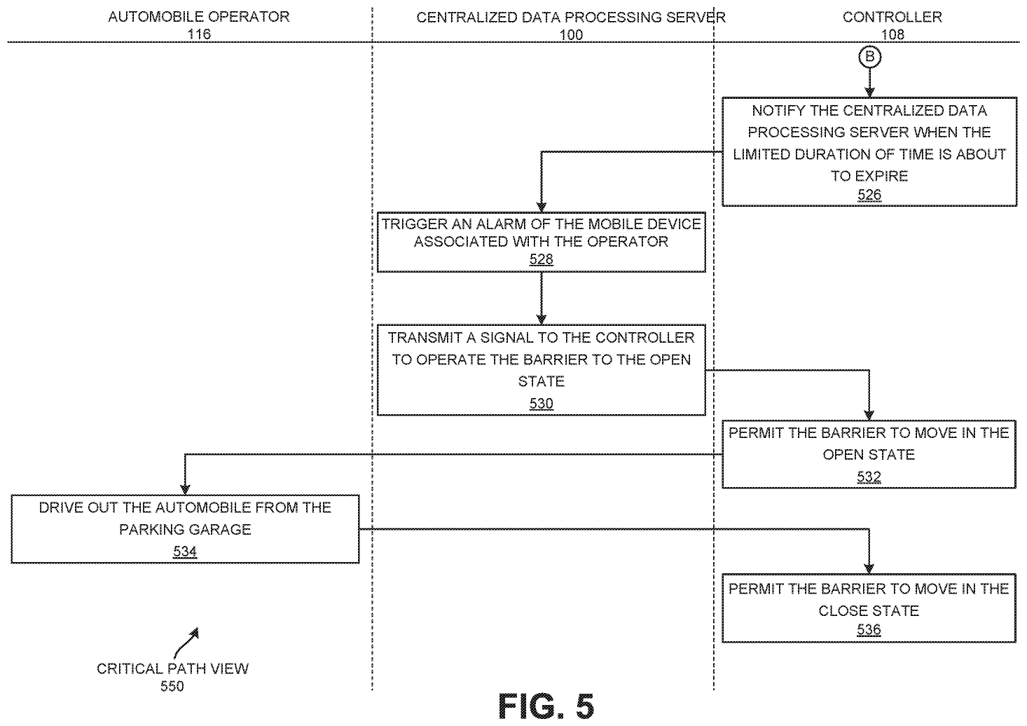

FIG. 5 is a critical path view 550 illustrating a flow based on time where an automobile operator 116 requests an access (e.g., access request 200) to a parking garage 110 and a secure physical space 112 in the parking garage 110 for a limited duration of time (e.g., allotted access time 402) using a centralized data processing server 100 of FIG. 1, according to one embodiment. In step 502, the automobile operator 116 may request to access (e.g., access request 200) the parking garage 110 and the secure physical space 112 of the parking garage 110 through a mobile device 118. In step 504, the centralized data processing server 100 may communicate real-time parking space availability (e.g., space availability and payment request 202) in the parking garage 110 along with a payment request to the mobile device 118, according to one embodiment.

In step 506, the automobile operator 116 may make the payment 204 using a mobile device 118 through a network 107. In step 508, the centralized data processing server 100 may allot the parking spot (e.g., allotted parking spot 400) for the requested automobile operator 116. In step 510, the centralized data processing server 100 may communicate the allotted parking spot 400 information with an authentication code 404 to the mobile device 118 of the automobile operator 116. In step 512, the automobile operator 116 may enter the valid authentication code 404. In step 514, the centralized data processing server 100 may transmit a signal (e.g., transition signal 206) to the controller 108 to operate the barrier 114 to an open state on entering the valid authentication code 404, according to one embodiment.

In step 516, a controller 108 may permit the barrier 114 to move in the open state. In step 518, the automobile operator 116 may drive the automobile 120 into the parking garage 110 and park the automobile 120 at the allotted parking spot 400. In step 520, the controller 108 may permit the barrier 114 to move in the close state. In step 522, the centralized data processing server 100 may authorize the automobile operator 116 to access the secure physical space 112 for a limited duration of time (e.g., allotted access time 402). In step 524, the controller 108 may track the limited duration of time (e.g., allotted access time 402) using an access control hardware 208, according to one embodiment.

In step 526, the controller 108 may notify the centralized data processing server 100 when the limited duration of time (e.g., allotted access time 402) is about to expire. In step 528, the centralized data processing server 100 may trigger an alarm (e.g., trigger alarm 212) of the mobile device 118 associated with the operator 116. In step 530, the centralized data processing server 100 may transmit a signal (e.g., transition signal 206) to the controller 108 to operate the barrier 114 to a close state. In step 532, the controller 108 may permit the barrier 114 to move in the open state. In step 534, the automobile operator 116 may drive out the automobile 120 from the parking garage 110. In step 536, the controller 108 may permit the barrier 114 to move in the close state, according to one embodiment.

FIG. 7 is a process flow 650 detailing the operations involved in accessing the parking garage 110 and the secure physical space 112 in the parking garage 110 for a limited duration of time (e.g., allotted access time 402) using the centralized data processing server 100 of FIG. 1, according to one embodiment. In operation 602, an automobile operator 116 may request to access the parking garage 110 and a secure physical space 112 of the parking garage 110 through a mobile device 118. In operation 604, the centralized data processing server 100 may communicate real-time parking space availability (e.g., space availability and payment request 202) in the parking garage 110 and a payment request to the mobile device 118 associated with the automobile operator 116 through a controller 108, according to one embodiment.

In operation 606, the centralized data processing server 100 may allot a parking spot for the requested automobile operator 116 upon completion of the payment 204 procedure. In operation 608, the centralized data processing server 100 may communicate the allotted parking spot 400 information with an authentication code 404 to open a garage barrier 114 to the mobile device 118. In operation 610, the centralized data processing server 100 may transmit a signal (e.g., transition signal 206) through the controller 108 to the barrier 114 to permit the barrier 114 to move in the open state on entering the valid authentication code 404 to enable the automobile 120 to drive into the parking garage 110 and park the automobile 120 at the allotted parking spot 400, according to one embodiment.

In operation 612, the centralized data processing server 100 may authorize the automobile operator 116 to access the secure physical space 112 for a limited duration of time (e.g., allotted access time 402). In operation 614, the centralized data processing server 100 may trigger an alarm (e.g., trigger alarm 212) of the mobile device 118 associated with the operator 116 when the limited duration of time (e.g., allotted access time 402) to access the secure physical space 112 is about to expire. In operation 616, the centralized data processing server 100 may transmit a signal (e.g., transition signal 206) through the controller 108 to the barrier 114 to permit the barrier 114 to move in the open state to enable the automobile 120 to exit from the parking garage 110, according to one embodiment.

An example embodiment will now be described. John Doe may be working as a cab driver at DC Cab Services. John may have to roam streets for long period of time picking up passengers from a specified location and quickly and safely delivering them to their drop-off destination. Sometimes John may have to work for longer period, sitting in his cabs all the time. John may not get sufficient time to rest during his working hours. This work schedule of John may lead him to health issues due to his limited movement for being in the sitting position for hours. Further, sitting in a cab for this much of time may also affect John's diets as he often needs to eat a lot of fast food during his working period.

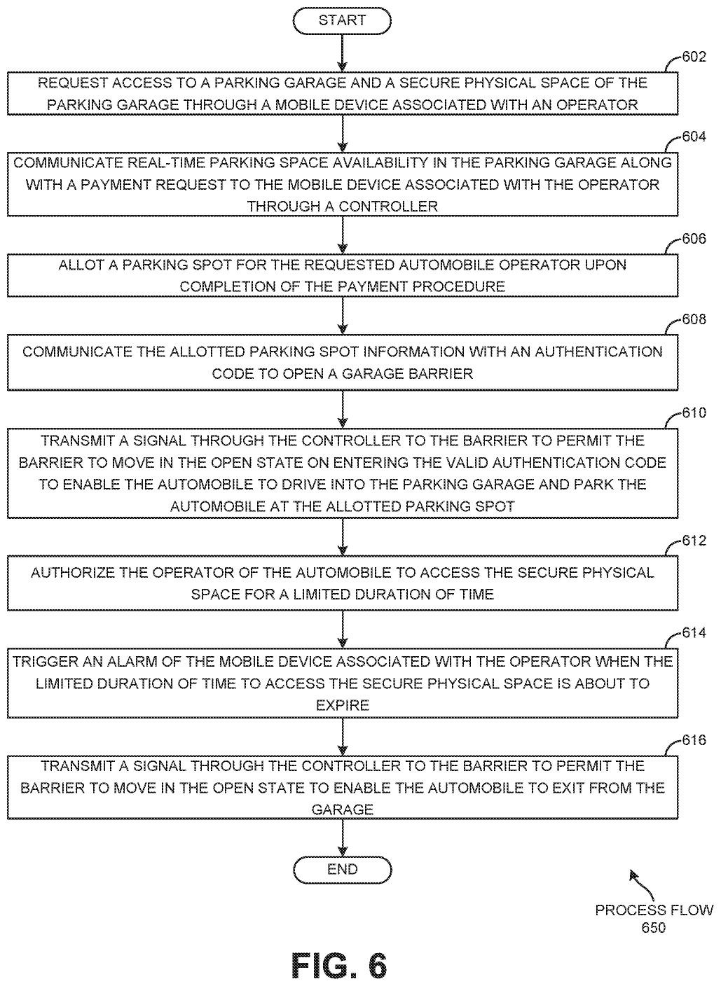

Considering these problems of employees, John's employer company DC Cab Services may decide to permit their cab drivers to take a break for a while and restrict new passengers to hire them. DC Cab Services may have collaborated with NYCP parking to provide this benefit for their cab drivers. NYCP parking may be enabled with the new access control system for their parking garages 110 with a secure physical space 112 as discussed in various embodiments of FIGS. 1-6. The new access control system for the parking garages 110 may enable John to send a request (e.g., access request 200) to a centralized data processing server 100 through his mobile device 118 to access the parking garage 110 and the secure physical space 112 of the parking garage 110.

The centralized data processing server 100 as discussed in various embodiments of FIGS. 1-6 may analyse the parking garage 110 and transmit real time parking space availability (e.g., space availability and payment request 202) in the parking garage 110. John may receive an allotted parking spot 400 and an authentication code 404 to help recognize the valid user (e.g., automobile operator 116). The centralized data processing server 100 may send a command (e.g., transition signal 206) to the barrier 114 of FIGS. 1-6 to transit to an open state from a closed state. John may enter into the garage 110 and park the automobile 120 at the allotted parking spot 402.

The access control system as discussed in various embodiments of FIGS. 1-6 may allow John to access the secure physical space of the parking garage for limited duration of time (e.g., allotted access time 402). John may enter the secure physical space 112 as discussed in various embodiments of FIGS. 1-6 to access a set of services (such as taking rest for a while, having lunch, using his personal locker etc.) for limited duration of time (e.g., allotted access time 402). John may receive an alarm signal (e.g., trigger alarm 212) to notify that his limited duration of access time (e.g., allotted access time 402) is about to expire. John may drive out from the parking garage 110 to continue his job.

The various embodiments of FIGS. 1-6 of the access control system for the parking garage with the secure physical space may have freshened up John by enabling him to take a break time from his work. John may feel more active to continue his job after taking short rest from his busy work schedule. In addition, the use of the new access control system for their parking garages with the secure physical space as discussed in various embodiments of FIGS. 1-6 may help DC Cab Services to satisfy the needs of their employees by introducing new facility to their cab drivers, indirectly enhancing overall profit of DC Cab Services.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device). Accordingly, the specification and drawings are to be regarded in an illustrative rather than a restrictive sense.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. An access control system of a parking garage, comprising:
a barrier to physically move in a manner such that an open state of the barrier to permit an automobile to transgress the barrier and enter the parking garage and a closed state of the barrier to restrict the automobile from entering the parking garage;
a controller electromechanically coupled with the barrier to communicate a signal to the barrier to permit the barrier to move in any one of the open state and the closed state based on a command of a centralized data processing system;
a secure physical space in the parking garage designated for non-automobile parking uses; and
an access control hardware of the secure physical space to restrict access to the secure physical space for a limited duration of time to an operator of the automobile when the command of the centralized data processing system communicates to the controller to transition the barrier from the closed state to the open state.

2. The access control system of claim 1, wherein the command of the centralized data processing system is triggered in response to a request from a mobile device associated with the operator of the automobile requesting access to the secure physical space of the parking garage.

3. The access control system of the parking garage of claim 2, wherein the secure physical space is a break room that permits the operator of the automobile to access a set of services to permit the operator to get access to at least one of a beverage, a snack, a seating area, and access to an internet service for the limited duration of time.

4. The access control system of the parking garage of claim 3, wherein the limited duration of time is set by any one of a ride sharing service through which the operator of the vehicle is employed and a proprietor of the parking garage.

5. The access control system of the parking garage of claim 4, wherein the mobile device associated with the operator of the automobile to automatically trigger an alarm when the limited duration of time is about to expire, signaling to the automobile along with the operator that they must exit the break area within the limited duration of time.

6. The access control system of the parking garage of claim 5, wherein an announcement is at least one of auditorily and visually triggered in the secure physical space announcing that the automobile of the operator must soon leave when the limited duration of time is about to expire.

7. The access control system of the parking garage of claim 6, wherein a time-based fine is assessed to at least one of the operator of the vehicle and the ride sharing service by a proprietor of the parking garage based on an excess time when the limited duration of time is exceeded.

8. The access control system of the parking garage of claim 7, wherein the barrier remains closed until the time-based fine is paid.

9. The access control system of the parking garage of claim 8, wherein the time-based fine is paid by the operator through the mobile device associated with the operator.

10. The access control system of the parking garage of claim 2, wherein the secure physical space is a storage locker room that permits the operator of the automobile to access to automatically open the storage locker with the mobile device when the operator approaches the storage locker during the limited duration of time.

11. The access control system of the parking garage of claim 1, wherein the secure physical space is at least one of a bathroom, a restroom, a storage locker, an exhibition space, a cafe, a break room, a convenience store, a shopping mall, a restaurant, a retail store, an office space, an electric vehicle charging station and a bicycle repair station.

12. The access control system of the parking garage of claim 2, wherein when the command of the centralized data processing system communicates to the controller to transition the barrier from the closed state to the open state, the command also allocates an available parking spot in the parking garage in which the automobile should park.

13. The access control system of the parking garage of claim 12, wherein the operator receives a visual display of where the automobile is to park in the available parking spot through a navigation guidance delivered to the mobile device of the operator.

14. An access control system of a parking garage, comprising:
a barrier:
to physically move in a manner such that an open state of the barrier to permit an automobile to transgress the barrier and enter the parking garage and a closed state of the barrier to restrict the automobile from entering the parking garage;
a centralized data processing system with a processor and a memory:
to communicate real-time parking space availability in the parking garage to a mobile device associated with an operator,
to allocate an available parking spot in the parking garage to park the automobile of the requested automobile operator, and
to communicate to a command to transition the barrier from the closed state to the open state;
a controller with an access control hardware of a secure physical space:
to restrict access to the secure physical space for a limited duration of time to the operator of the automobile when the command of the centralized data processing system communicates to the controller to transition the barrier from the closed state to the open state,
wherein the secure physical space in the parking garage designated for non-automobile parking uses; and
to communicate a signal to the barrier to permit the barrier to move in any one of the open state and the closed state based on the command of the centralized data processing system.

15. The access control system of the parking garage of claim 14, wherein the command of the centralized data processing system is triggered in response to a request from the mobile device associated with the operator of the automobile requesting access to the secure physical space of the parking garage.

16. The access control system of the parking garage of claim 15, wherein the secure physical space is a break room that permits the operator of the automobile to access a set of services to permit the operator to get access to at least one of a beverage, a snack, a seating area, and access to an internet service for the limited duration of time.

17. The access control system of the parking garage of claim 16 wherein the limited duration of time is set by any one of a ride sharing service through which the operator of the vehicle is employed and a proprietor of the parking garage.

18. The access control system of the parking garage of claim 17, wherein an announcement is at least one of auditorily and visually triggered in the secure physical space announcing that the automobile of the operator must soon leave when the limited duration of time is about to expire.

19. The access control system of the parking garage of claim 18, wherein a time-based fine is assessed to at least one of the operator of the vehicle and the ride sharing service by the proprietor of the parking garage based on an excess time when the limited duration of time is exceeded.

20. The access control system of the parking garage of claim 19, wherein the barrier remains closed until the time-based fine is paid.

21. The access control system of the parking garage of claim 20, wherein the time-based fine is paid by the operator through the mobile device associated with the operator.

22. The access control system of the parking garage of claim 15, wherein the secure physical space is a storage locker room that permits the operator of the automobile to access to automatically open the storage locker with the mobile device when the operator approaches the storage locker during the limited duration of time.

23. The access control system of the parking garage of claim 14, wherein the secure physical space is at least one of a bathroom, a restroom, a storage locker, an exhibition space, a cafe, a break room, a convenience store, a shopping mall, a restaurant, a retail store, an office space, an electric vehicle charging station and a bicycle repair station.

24. The access control system of the parking garage of claim 15, wherein the barrier has a display unit to show an allocated parking spot for the automobile and a direction to the allotted parking spot to park the automobile.

25. A method of a centralized data processing server comprising:
requesting access to a parking garage and a secure physical space of the parking garage through a mobile device associated with an operator;
communicating real-time parking space availability in the parking garage along with a payment request to the mobile device associated with the operator through a controller;
allotting a parking spot for the requested automobile operator upon completion of the payment procedure;
communicating the allotted parking spot information with an authentication code to open a garage barrier;
transmitting a signal through the controller to the barrier to permit the barrier to move in the open state on entering the valid authentication code to enable the automobile to drive into the parking garage and park the automobile at the allotted parking spot;
authorizing the operator of the automobile to access the secure physical space for a limited duration of time;
triggering an alarm of the mobile device associated with the operator when the limited duration of time to access the secure physical space is about to expire; and
transmitting a signal through the controller to the barrier to permit the barrier to move in the open state to enable the automobile to exit from the garage.

26. The method of the centralized data processing server of claim 25, wherein the secure physical space is a break room that permits the operator of the automobile to access a set of services to permit the operator to get access to at least one of a beverage, a snack, a seating area, and access to an internet service for the limited duration of time.

27. The method of the centralized data processing server of claim 26, wherein the limited duration of time is set by any one of a ride sharing service through which the operator of the vehicle is employed and a proprietor of the parking garage.

28. The method of the centralized data processing server of claim 27, wherein an announcement is at least one of auditorily and visually triggered in the secure physical space announcing that the automobile of the operator must soon leave when the limited duration of time is about to expire.

29. The method of the centralized data processing server of claim 28, wherein a time-based fine is assessed to at least one of the operator of the vehicle and the ride sharing service by a proprietor of the parking garage based on an excess time when the limited duration of time is exceeded.

30. The method of the centralized data processing server of claim 29, wherein the barrier remains closed until the time-based fine is paid.

31. The method of the centralized data processing server of claim 30, wherein the time-based fine is paid by the operator through the mobile device associated with the operator.

32. The method of the centralized data processing server of claim 26, wherein the secure physical space is a storage locker room that permits the operator of the automobile to access to automatically open the storage locker with the mobile device when the operator approaches the storage locker during the limited duration of time.

33. The method of the centralized data processing server of claim 25, wherein the secure physical space is at least one of a bathroom, a restroom, a storage locker, an exhibition space, a cafe, a break room, a convenience store, a shopping mall, a restaurant, a retail store, an office space, an electric vehicle charging station and a bicycle repair station.

34. The method of the centralized data processing server of claim 25, wherein the authentication code to open the garage barrier is at least one of a QR code, a barcode, an alphanumeric character, and a pattern.

35. The method of the centralized data processing server of claim 25, wherein when the command of the centralized data processing system communicates to the controller to transition the barrier from the closed state to the open state, the command also allocates an available parking spot in the parking garage in which the automobile should park.

36. The method of the centralized data processing server of claim 35, wherein the operator receives a visual display of where the automobile is to park in the available spot through a navigation guidance delivered to the mobile device of the operator.
